(19) United States
(12) Patent Application Publication
(10) Pub. No.: US 2014/0071264 A1
(43) Pub. Date: Mar. 13, 2014

(54) IMAGE CAPTURE APPARATUS AND CONTROL METHOD THEREOF

(71) Applicant: SAMSUNG ELECTRONICS CO., LTD., Suwon-si (KR)

(72) Inventor: Jin Hwan Seo, Seoul (KR)

(73) Assignee: SAMSUNG ELECTRONICS CO., LTD., Suwon-si (KR)

(21) Appl. No.: 14/023,639

(22) Filed: Sep. 11, 2013

(30) Foreign Application Priority Data
Sep. 11, 2012 (KR) 10-2012-0100695

(51) Int. Cl. H04N 9/73

(52) U.S. Cl. CPC H04N 9/735
USPC 348/81

(57) ABSTRACT

Disclosed herein are an image capturing apparatus and a control method thereof. The image capture apparatus includes an imaging device that converts an input optical signal into an electrical signal to generate image data, an image signal processor that analyzes color information of the image data and performs white balance compensation on the image data, an underwater recognition sensor that detects whether an image capture condition is an underwater condition, and a controller that determines whether the image capture condition is the underwater condition based on the color information analysis result of the image signal processor or the detection result of the underwater recognition sensor. The controller controls the image signal processor to perform the white balance compensation based on the underwater condition upon the determination that the image capture condition is the underwater condition.

### CROSS-REFERENCE TO RELATED APPLICATION(S)

This application claims the priority benefit under 35 U.S.C. §119(a) from Korean Patent Application No. 10-2012-0100695, filed on Sep. 11, 2012 in the Korean Intellectual Property Office, the disclosure of which is incorporated herein by reference in its entirety.

### BACKGROUND

1. Field

Various embodiments of the invention relate to white balance compensation of an image capture apparatus to express correct colors when a still image or a moving image is captured.

2. Description of the Related Art

An imaging device of a digital image capture apparatus is a device to convert input light into an electric signal. Depending upon light source type, colors of an image may be expressed differently from real colors. For example, in a case in which different light sources are used, a subject in an image may be expressed as different colors. In a case in which colors of a subject are expressed differently from real colors, colors of an image may be compensated to be more similar to real colors, which is referred to as white balance compensation.

White balance compensation may include auto white balance compensation, manual white balance compensation, and custom white balance compensation. In the auto white balance compensation, white balance compensation is automatically performed according to a white balance compensation algorithm provided in an image capture apparatus. Since white balance compensation quality depends upon the white balance compensation algorithm, the white balance compensation may not be correctly performed. In the manual white balance compensation, a user sets proper white balance compensation conditions based on type of a light source. In the manual white balance compensation, however, the white balance compensation conditions are limited to white balance compensation forms provided in an image capture apparatus. Accordingly, it may be difficult to achieve desired white balance compensation results in a condition that is different from predetermined white balance compensation forms. In the custom white balance compensation, a white balance compensation coefficient is set based on an image obtained by previously capturing a white subject under specific lighting conditions, and white balance compensation is performed using the set white balance compensation coefficient. In the custom white balance compensation, however, a series of processes of obtaining an image by capturing a white subject under specific lighting conditions and setting a white balance compensation coefficient based on the obtained image is necessary. Accordingly, a quick image capture may not be possible or this compensation may not be suitable for persons who are not skilled at manipulating image capture apparatuses.

### SUMMARY

Various embodiments of the invention provide an image capture apparatus and a control method thereof wherein white balance compensation of the image capture apparatus is automatically performed, and white balance compensation based on colors of water is automatically performed particularly in a case in which a current image capture condition is an underwater condition.

Additional embodiments will be set forth in part in the description which follows and, in part, will become apparent from the description, or may be learned by practicing the invention.

In accordance with one embodiment, an image capture apparatus includes an imaging device that converts an input optical signal into an electrical signal to generate image data, an image signal processor that analyzes color information of the image data and performs white balance compensation on the image data, an underwater recognition sensor that detects whether an image capture condition is an underwater condition, and a controller that determines whether the image capture condition is the underwater condition, based on the color information analysis result of the image signal processor or the detection result of the underwater recognition sensor. The controller also controls the image signal processor to perform the white balance compensation, based on the underwater condition, upon the determination that the image capture condition is the underwater condition.

The image signal processor may perform the color information analysis on at least one region of a predetermined size at a bottom corner of an entire area of the image.

The image capture apparatus may further include a white balance map that includes a color temperature range that corresponds to colors of water. The image signal processor may perform the white balance compensation based on the white balance map and the underwater condition.

The colors of water in the white balance map may include blue-based colors that correspond to a bottom or inner wall of a pool.

The color temperature range that corresponds to the colors of water in the white balance map may be about 7850K to 9350K.

The image capture apparatus may further include a display unit that displays a message when the image capture condition is the underwater condition.

The message may indicate that the white balance compensation based on the underwater condition will be performed.

In accordance with another embodiment, an image capture apparatus includes an imaging device that converts an input optical signal into an electrical signal to generate image data, an image signal processor that performs white balance compensation on the image data, an underwater recognition sensor that detects whether an image capture condition is an underwater condition, and a controller that determines whether the image capture condition is the underwater condition based on the detection result of the underwater recognition sensor. The controller controls the image signal processor to perform the white balance compensation, based on the underwater condition, upon the determination that the image capture condition is the underwater condition.

The image capture apparatus may further include a white balance map that includes a color temperature range that corresponds to colors of water. The image signal processor may perform the white balance compensation based on the white balance map and the underwater condition.

The colors of water in the white balance map may include blue-based colors that correspond to a bottom or inner wall of a pool.

The color temperature range that corresponds to the colors of water in the white balance map may be about 7850K to 9350K.

In accordance with another embodiment, an image capture apparatus includes an imaging device that converts an input optical signal into an electrical signal to generate image data, an image signal processor that analyzes color information of the image data and performs white balance compensation on the image data, and a controller that determines whether an image capture condition is an underwater condition based on the color information analysis result of the image signal processor. The controller controls the image signal processor to perform the white balance compensation, based on the underwater condition, upon the determination that the image capture condition is the underwater condition.

The image signal processor may perform the color information analysis on at least one region of a predetermined size at a bottom corner of an entire area of the image.

The image capture apparatus may further include a white balance map that includes a color temperature range that corresponds to colors of water. The image signal processor may perform the white balance compensation based on the white balance map and the underwater condition.

The colors of water in the white balance map may include blue-based colors that correspond to a bottom or inner wall of a pool.

The color temperature range that corresponds to the colors of water in the white balance map may be about 7850K to 9350K.

In accordance with a further embodiment, a control method of an image capture apparatus includes converting an input optical signal into an electrical signal to generate image data, analyzing color information of the image data, detecting whether an image capture condition is an underwater condition, determining whether the image capture condition is the underwater condition based on the color information analysis result or the detection result, and performing white balance compensation on the image data, based on the underwater condition, upon determining that the image capture condition is the underwater condition.

The color information analysis may be performed on at least one region of a predetermined size at a bottom corner of an entire area of the image.

The control method may further include providing a white balance map that includes a color temperature range that corresponds to colors of water. Performing the white balance compensation may include performing the white balance compensation based on the white balance map and the underwater condition.

The colors of water in the white balance map may include blue-based colors that correspond to a bottom or inner wall of a pool.

The color temperature range that corresponds to the colors of water in the white balance map may be about 7850K to 9350K.

The control method may further include displaying a message through a display unit when the image capture condition is the underwater condition. The message may indicate that the white balance compensation based on the underwater condition will be performed.

### BRIEF DESCRIPTION OF THE DRAWINGS

These and/or other embodiments will become apparent and more readily appreciated from the following description of the embodiments, taken in conjunction with the accompanying drawings of which:

FIGS. 1(A) and 1(B) are diagrams showing an image capture apparatus, according to an embodiment;

FIG. 2 is a block diagram showing a control system of the image capture apparatus shown in FIG. 1;

FIG. 3 is a flowchart showing an image capture method, according to an embodiment;

FIGS. 4(A) and 4(B) are diagrams showing a white balance compensation concept, according to an embodiment;

FIG. 5 is a diagram showing RGB values of colors representing water;

FIG. 6 is a diagram showing a white balance map for white balance compensation, according to an embodiment;

FIG. 7 is a flowchart showing a control method of an embodiment of white balance compensation;

FIG. 8(A) is a diagram showing a color information analysis region of the control method shown in FIG. 7;

FIG. 8(B) is a diagram showing a message indicating a current image capture condition, according to the control method shown in FIG. 7;

FIG. 9 is a flowchart showing another embodiment of white balance compensation of the image capture method shown in FIG. 3; and

FIG. 10 is a flowchart showing a further embodiment of white balance compensation of the image capture method shown in FIG. 3.

### DETAILED DESCRIPTION

Reference will now be made in detail to the embodiments of the invention, examples of which are illustrated in the accompanying drawings, wherein like reference numerals refer to like elements throughout.

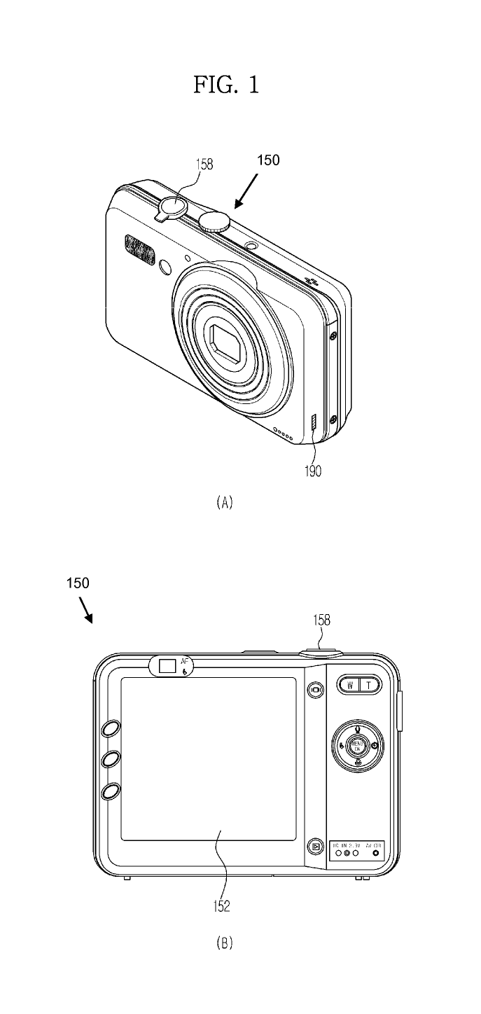

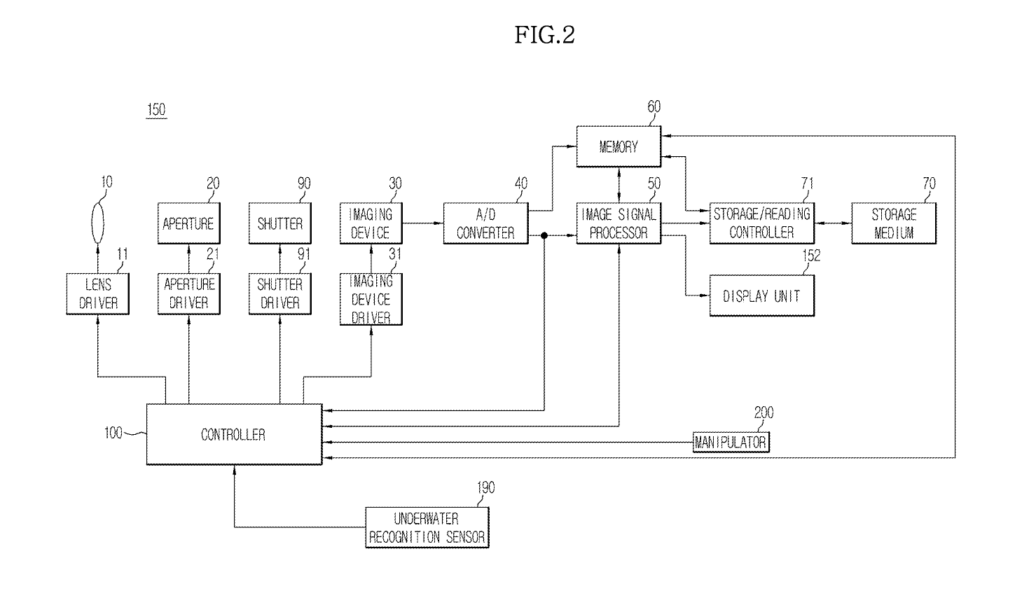

FIGS. 1(A) and 1(B) are diagrams showing an image capture apparatus, according to an embodiment. FIG. 1(A) illustrates a digital camera, which captures images of a subject, converts the images into digital data, and records the digital data in a storage device, as an example of an image capture apparatus 150. However, the embodiments are not limited to the digital camera as shown in FIGS. 1(A) and 1(B) and may include other image capture apparatuses, such as a camcorder or a mobile communication terminal (with a camera). Also, other embodiments may include a case in which a television or a computer is communicatively connected to an image capture apparatus 150 via a wired or wireless communication device. An image may be a still image or a moving image. Image capture is an operation of acquiring an electric signal corresponding to an image of a subject and storing the acquired electric signal as image data. The stored image data may be reproduced through a monitor, television, or mobile image device. In the image capture apparatus 150 of FIG. 1(B), a display unit 152 may display an image of a subject input through a lens 10 (FIG. 2) before the image is captured, and, after the image is captured, may display the captured image. Also, while the image of the subject or the captured image is displayed, a menu and information related to image capture and a user interface to enable setting of various options may be displayed together with the image. The image capture apparatus 150 also includes a shutter release button 158. The image capture apparatus 150 may further include an underwater recognition sensor 190.

FIG. 2 is a block diagram showing a control system of the image capture apparatus 150 shown in FIGS. 1(A) and 1(B). Overall operation of the image capture apparatus 150 is controlled by a controller 100. In addition, the image capture apparatus 150 includes a manipulator 200 to generate a predetermined electric signal in response to user manipulation and to transmit the electric signal to the controller 100 such that user manipulation is transmitted to the controller 100. The electric signal from the manipulator 200 is transmitted to the controller 100 such that the controller 100 controls the image capture apparatus 150 according to the electrical signal. The manipulator 200 in one example is different from the user interface of the display unit 152. For example, the user interface of the display unit 152 may be a software-based graphical user interface, whereas the manipulator 200 may be a hardware-based mechanical manipulator. Examples of the manipulator 200 include an arrow key, a command dial, a wheel, and various buttons.

The controller 100 controls a lens driver 11, an aperture driver 21, a shutter driver 91, and an imaging device driver 31. Consequently, the position of a lens 10, an opening degree of an aperture 20, release of a shutter 90, and the sensitivity of an imaging device 30 are controlled by the controller 100. The imaging device 30 converts an input optical signal into an analog electrical signal. An analog/digital converter 40 converts the analog electrical signal into digital data. Alternatively, the imaging device 30 may perform digital conversion without using the analog/digital converter 40. In an embodiment, an electronic shutter is provided instead of the shutter 90, and the shutter function is performed through electronic control of the imaging device 30, where the controller 100 may control the imaging device 30 to perform a shutter function.

The image data, generated by the imaging device 30 and converted by the analog/digital converter 40, may be input to an image signal processor 50 via a memory 60 or directly input to the image signal processor 50. The image data may also be input to the controller 100 as needed. The memory 60 may include a read only memory (ROM) or a random access memory (RAM). The image signal processor 50 may perform digital signal processing, such as Gamma correction and white balance change, as needed.

The image data output from the image signal processor 50 are transmitted to the display unit 152, by which the image data are displayed as an image. In this embodiment, the display unit 152 may be a touchscreen, which is touched to perform a predetermined input operation. The image data output from the image signal processor 50 are input to a storage/reading controller 71 via the memory 60 or directly input to the storage/reading controller 71. The storage/reading controller 71 stores the image data in a storage medium 70 as an image file according to user request or a predetermined automatic storage routine. The storage/reading controller 71 may read image data from an image file stored in the storage medium 70 and provides the image data to the display unit 152 via the memory 60 or another route such that the display unit 152 displays an image. The storage medium 70 may be detachably mounted in a memory slot or fixedly mounted in the image capture apparatus 150.

The image capture apparatus 150 may include an underwater recognition sensor 190 that detects whether a capture condition of the image capture apparatus 150 is an underwater condition. The image capture apparatus 150 is configured to perform white balance compensation, based on colors of water, when the capture condition is the underwater condition. The underwater condition, in one example, is when the image capture apparatus 150 is submerged in water. Upon detecting that the image capture apparatus 150 is submerged in water, the underwater recognition sensor 190 generates a detection signal. The detection signal is transmitted to the controller 100 such that the controller 100 recognizes that the capture condition of the image capture apparatus 150 is the underwater condition. The underwater recognition sensor 190 may be a sensor using change of electrical properties (resistance or capacitance) generated between a plurality of electrodes when water is introduced between the electrodes. However, any sensor may be used so long as the sensor detects water.

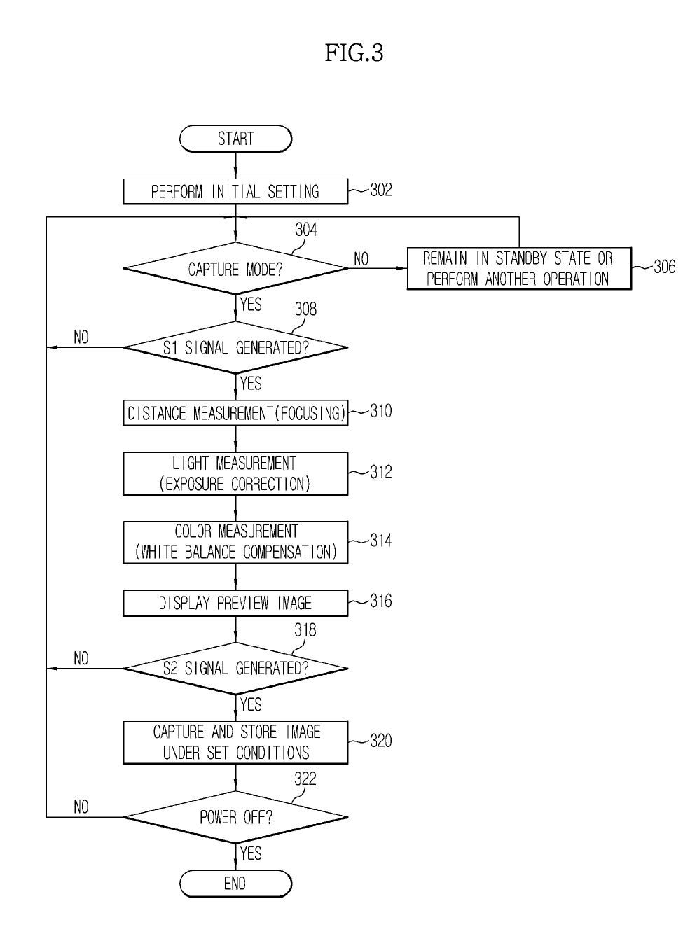

FIG. 3 is a flowchart showing an image capture method according to an embodiment. As shown in FIG. 3, when the image capture apparatus 150 is turned on, the controller 100 performs an initial setting, for example, the controller 100 initializes flags and control variables (302). Also, the controller 100 determines a current operation mode set through the manipulator 200. Upon determining that the current operation mode is a capture mode (YES of 304), the controller 100 performs an operation for capture. Upon determining that the current operation mode is not the capture mode (NO of 304), on the other hand, the controller 100 remains in a standby state or performs another operation (306).

In the capture mode, the controller 100 checks whether an S1 signal has been generated by half pressing of a shutter release button 158 (308). The half pressing of the shutter release button 158 is to slightly press the shutter release button 158 such that the shutter release button 158 is not fully pressed. The term ‘half pressing’ of the shutter release button 158 is used to distinguish between half pressing of the shutter release button 158 and full pressing of the shutter release button 158. However, half pressing of the shutter release button 158 does not mean that the shutter release button 158 must be half pressed. The full pressing of the shutter release button 158 is to fully press the shutter release button 158 such that the shutter release button 158 is pressed deeper than in the half pressing of the shutter release button 158 to generate an S2 signal. An image is captured in response to the generation of the S2 signal. Upon determining that the S1 signal has been generated through the half pressing of the shutter release button 158 (YES of 308), the controller 100 controls relevant components to perform focusing through distance measurement (310), exposure correction through light measurement (312), and white balance compensation through color measurement (314). The controller 100 controls the lens driver 11 to perform focusing through distance measurement (310). The distance between the image capture apparatus 150 and a subject at a position corresponding to a focus point is measured to bring the subject into focus (310). Also, the controller 100 detects the brightness of an image through analysis of a brightness signal of a live view image, calculates an exposure correction value suitable for proper exposure, and stores the calculated exposure correction value in the memory 60 (312). The controller 100 in one example analyzes color information of the live view image, calculates a white balance compensation coefficient to correct color expression, and stores the calculated white balance compensation coefficient in the memory 60 (314). For example, the controller 100 of the image capture apparatus 150 determines whether a capture condition of the image capture apparatus 150 is an underwater condition when performing white balance compensation. Upon determining that the capture condition of the image capture apparatus 150 is the underwater condition, the controller 100 controls the image signal processor 50 to perform white balance compensation suitable for underwater capture. Also, the controller 100 generates a preview image, to which the distance measurement (focusing), light measurement (exposure correction), and color measurement (white balance compensation) results have been applied, and displays the preview image through the display unit 152 (316). Upon determining that the S1 signal has not been generated (NO of 308), the procedure returns to the operation following the initial setting operation (302).

The controller 100 determines whether an S2 signal has been generated by a full pressing of the shutter release button 158 (318). Upon determining that the S2 signal has been generated (YES of 318), an image is captured under the previously set focus, exposure correction, and white balance compensation conditions, and captured image data are stored in the memory 60 or the storage medium 70 (320). To this end, the controller 100 controls the aperture driver 21, the shutter driver 91, and the imaging device driver 31 to set an aperture value, shutter speed, and an ISO value based on the exposure correction value stored in the memory 60. Upon determining that the half pressing of the shutter release button 158 has been released after the generation of the S1 signal or the S2 signal has not been generated until a predetermined time elapses (NO of 318), the procedure returns to the operation following the initial setting operation (302). Also, when user manipulation to turn the image capture apparatus 150 off is performed after the completion of the image capture (YES of 322), the controller 100 stores in a nonvolatile memory data, such as parameters including the flags or control variables, set values, and set modes, necessary to operate the image capture apparatus 150 when the image capture apparatus 150 is turned on and turns the image capture apparatus 150 off. When the image capture apparatus 150 is not turned off after the completion of the image capture (NO of 322), the procedure returns to the operation following the initial setting operation (302).

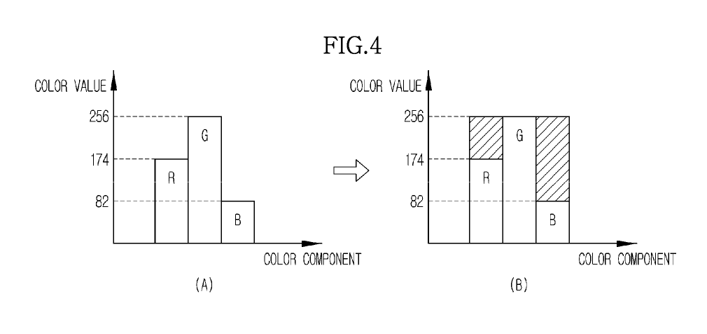

FIGS. 4(A) and 4(B) are diagrams showing a white balance compensation concept according to an embodiment. The image capture apparatus 150, such as a digital camera or a digital video camera, has a white balance compensation function to adjust hue of a captured image. The white balance compensation includes custom white balance compensation and auto white balance compensation. In the custom white balance compensation, a white subject is captured before a main subject is captured, a white balance coefficient is acquired, and the acquired white balance coefficient is applied to the entirety of an image during capture of the image.

In the auto white balance compensation, a white region is automatically detected from a captured image, a white balance coefficient is calculated from the detected white region, and the calculated white balance coefficient is applied to the entirety of an image.

In the auto white balance compensation, a region determined as white (hereinafter, referred to as a white region) is located in an input image, and a white balance coefficient for setting the RGB values of the white region to 1:1:1 is calculated while compensating white balance such that RGB values of the white region are 1:1:1. The white balance coefficient is applied to the entirety of the input image to compensate white balance. If the RGB values of the white region are 256, 256, and 256, the white balance coefficient necessary to set the RGB values of the white region to 1:1:1 is 0 with the result that color change due to white balance compensation does not occur in the remaining region of the input image. If the RGB values of the white region are 174, 256, and 82 (FIG. 4(A)), the white balance coefficient necessary to set the RGB values of the white region to 1:1:1 is 82:0:174 (FIG. 4(B)). Consequently, color values are increased with respect to the RGB values of the entirety of the input image by 82:0:174 to realize original colors. The RGB values of the white region are changed depending upon a light source type. That is, the RGB values of the white region are changed depending upon whether the light source is an incandescent lamp, fluorescent lamp, day light (sunlight), clouded sunlight, or other light source type. Consequently, white balance compensation is performed based on values suitable for the type of the light source to express correct colors.

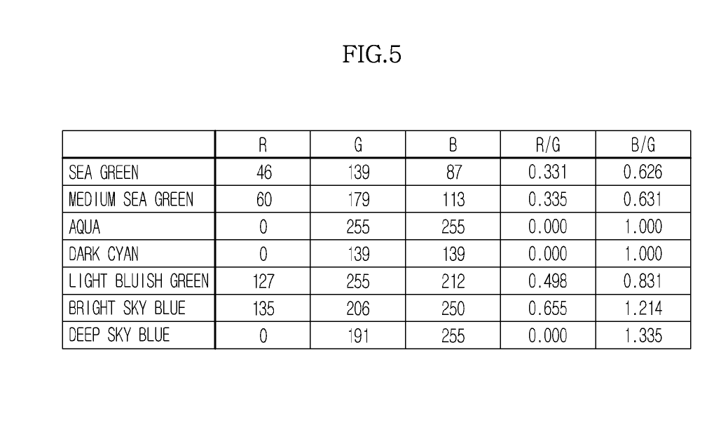

FIG. 5 is a diagram showing RGB values of colors representing water. As shown in FIG. 5, the colors representing water have R values less than G or B values. In addition, a ratio of the B values to the G values is maintained within a predetermined range. Based on these characteristics, colors of a specific region of an input image having G values and B values of 75 or more, an R/G ratio of 0.7 or less, and a B/G ratio of 0.5 or more may be determined to be colors representing water. Consequently, this condition is set as a predetermined value used as a criterion for determination of colors as colors of water. For example, if RGB values extracted from a specific region of an input image are 50, 150, and 175, which satisfies the above condition, colors of the region are determined to be colors of water, which means that it may be determined that a current image capture condition is an underwater condition. As another example, if the extracted RGB values are 107, 142, and 35, which does not satisfy the above condition, colors of the region are determined to not be colors of water, which means that it may be determined that a current image capture condition is not an underwater condition.

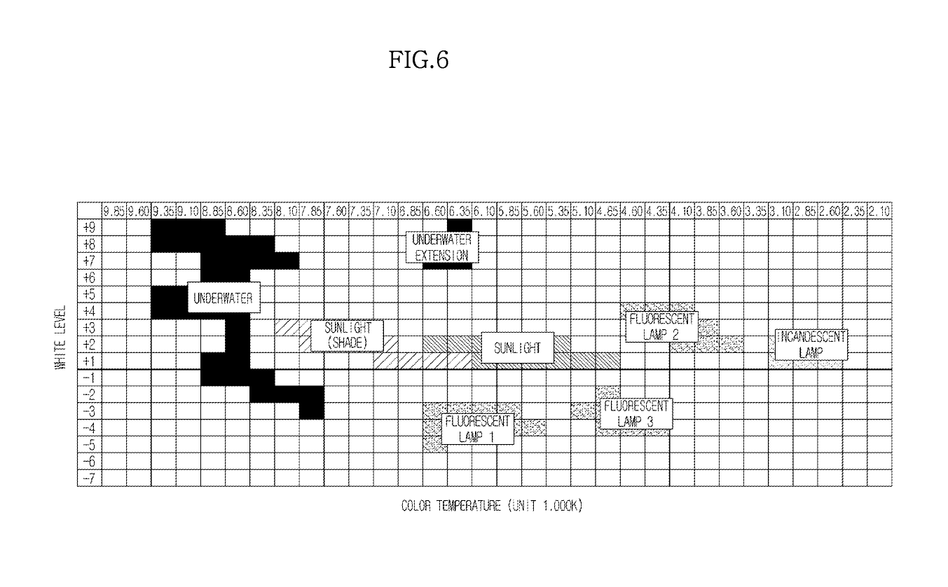

FIG. 6 is a diagram showing a white balance map for white balance compensation according to an embodiment. The white balance map shown in FIG. 6 is provided in the form of a lookup table, which may be referred to by the controller 100 of the image capture apparatus 150 according to the embodiment shown in FIGS. 1(A) and 1(B), and is stored in the memory 60. The controller 100 generates a control signal such that the image signal processor 50 performs white balance compensation based on the white balance map shown in FIG. 6.

In FIG. 6, the horizontal direction indicates color temperature, and the vertical direction indicates a white level. The middle (i.e. 0) between +1 and −1 in the vertical direction has the highest white level. A color gradually becomes close to a primary color from the middle between +1 and −1 to opposite ends. Color temperature values are indicated in units of 1000K (Kelvin) in the horizontal direction. As the color temperature values are increased (toward the left), blue is increased. As the color temperature values are decreased (toward the right), yellow is increased. Generally, shade under the sun or clouded sunlight has a color temperature of about 6500 to 8000K, sunlight has a color temperature of about 5000 to 6000K, and an incandescent lamp/halogen lamp has a color temperature of about 2500 to 3200K. A fluorescent lamp has various color temperature ranges depending upon manufacturers. The white balance map is prepared to include various light source conditions, and an RGB ratio is adjusted to perform white balance compensation based on the white balance map.

In the embodiment of FIG. 6, a color temperature range corresponding to colors of water is included in the white balance map such that the color temperature range is used to perform white balance in an underwater condition. In the white balance map according to the embodiment, the color temperature range corresponding to the colors of water is about 7850K to 9350K. The color temperature range corresponding to the colors of water is high. This is because bluish green, similar to a color of a bottom or inner wall of an artificial pool, or blue, such as sky blue, is included in the white balance map. Since the colors of water are included in the white balance map, the colors of water are recognized as white when an image is captured in an artificial pool, and white balance compensation is performed based thereupon such that relatively correct white balance is achieved under the water to realize natural colors.

In conditions different from the underwater condition, if the white balance region is extended to bluish green or blue, which is a condition that is not derived from white under a general light source, the bluish green or the blue may be incorrectly recognized as white with the result that colors throughout an image may be distorted. Under the water, however, white balance compensation is performed with respect to bluish green shown through the bottom of a pool or blue shown through the surface of water such that the colors of water become transparent colors, and therefore, natural colors are realized in the entirety of the image. In the white balance map shown in FIG. 6, an artificial pool is referred to by way of example for “underwater” color temperatures and corresponding white levels. In addition, other underwater conditions, such as in a sea or lake (river) instead of the artificial pool, may be reflected in the white balance map to realize correct colors through correct white balance compensation based on various other underwater conditions. For example, water in a valley or a shallow river may not be blue but almost transparent unlike water in a pool. For water in the valley or the shallow river, therefore, white balance compensation included in a general white balance map region may be performed, or white balance compensation may be performed using a white balance compensation condition different from that for the artificial pool to realize normal colors of the image. Other underwater conditions may include a seawater condition and a freshwater condition. Distinction between the seawater condition and the freshwater condition may be possible through analysis of detection results based on a combination of a water sensor and a salinity sensor.

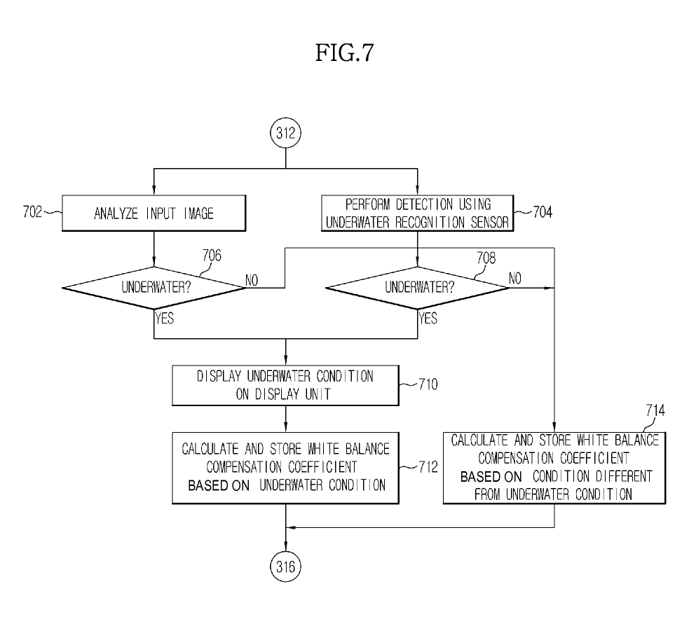

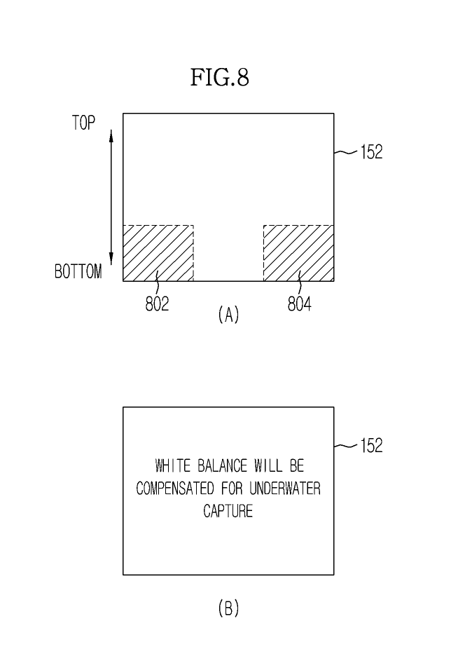

FIGS. 7, 8(A), and 8(B) are diagrams showing an embodiment of white balance compensation of the image capture method shown in FIG. 3. Specifically, FIG. 7 is a flowchart showing a control method of an embodiment of white balance compensation, and FIGS. 8(A) and 8(B) are diagrams showing a color information analysis region of the control method shown in FIG. 7. In the white balance compensation method shown in FIGS. 7, 8(A), and 8(B), an underwater condition is detected using both analysis of an input image and the underwater recognition sensor 190.

First, as shown in FIG. 7, color information of the input image is analyzed to determine whether a current image capture condition is an underwater condition (702). In addition, it is determined whether the current image capture condition is an underwater condition using the underwater recognition sensor 190 (704). In the embodiment shown in FIG. 7, the analysis result of the color information of the input image and/or the detection result of the underwater condition detection using the underwater recognition sensor 190 may be considered to determine whether the current image capture condition is an underwater condition. In order to further increase accuracy of the determination of the underwater condition, both the color information analysis result of the input image and the detection result of the underwater condition detection using the underwater recognition sensor 190 may be considered to determine whether the current image capture condition is an underwater condition.

An underwater condition determination concept through image analysis according to the embodiment will be described with reference to FIG. 8(A). In determination of the underwater condition through the image analysis according to the embodiment, first, color information of regions having a predetermined size at one or more corners of the entire area of an input image is analyzed. In one example, as shown in FIG. 8(A), color information of regions 802 and 804 having a predetermined size at opposite bottom corners of the entire area of the input image is analyzed. If colors of the regions 802 and 804 are recognized as the colors of water shown in FIG. 5, it is determined that the current image capture condition is an underwater condition. Color information of one of the regions 802 and 804 may be analyzed as needed. In one case in which a current image capture condition is an underwater condition, water may not be present in the upper part of the image (e.g., the upper corners) but is present in the lower part of the image. For example, the image capture apparatus 150 may be partially submerged in water. For this reason, the underwater condition is determined through analysis of colors in the lower part (e.g., the bottom corners) of the image. Also, in one case in which a portrait is included as a subject, the portrait is generally at the middle of the image, and a background occupies the corners of the image. For this reason, color information of the middle of the image is not analyzed but color information of the corners (e.g., bottom corners) of the image is analyzed to determine an underwater condition.

Referring back to FIG. 7, upon determining from the analysis result of the input image that the current image capture condition is an underwater condition (YES of 706) and upon determining from the detection result using the underwater recognition sensor 190 that the current image capture condition is an underwater condition (YES of 708), a message stating ‘white balance will be compensated for underwater capture’ may be displayed on the display unit 152 to indicate to a user that the current image capture condition is an underwater condition. Referring again to FIG. 8(B), this message is displayed on the display unit 152. Referring back to FIG. 7, as it is determined that the current image capture condition is an underwater condition, the controller 100 calculates and stores a white balance compensation coefficient based on the underwater condition (712). When an S2 signal is generated to capture an image, the image signal processor 50 performs white balance compensation with reference to the white balance compensation coefficient based on the underwater condition. Upon determining at operation 706 and/or operation 708 that the current image capture condition is not an underwater condition (NO of 706 or NO of 708), the controller 100 calculates and stores a white balance compensation coefficient based on another condition different from the underwater condition (714). In this case, when an S2 signal is generated to capture an image, the image signal processor 50 performs white balance compensation with reference to the white balance compensation coefficient based on the other condition different from the underwater condition.

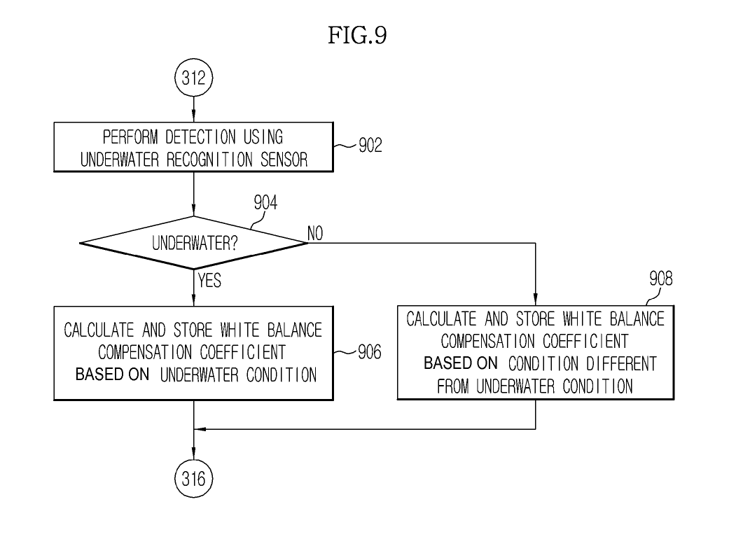

FIG. 9 is a flowchart showing another embodiment of white balance compensation of the image capture method shown in FIG. 3. In the white balance compensation method shown in FIG. 9, an underwater condition is detected using only the underwater recognition sensor 190 without analysis of an input image.

That is, it is determined whether a current image capture condition is an underwater condition using the underwater recognition sensor 190 (902). In this embodiment, it is determined whether the current image capture condition is an underwater condition using only the underwater recognition sensor 190 without analysis of the input image. Consequently, computational load applied to the controller 100 and the image signal processor 50 may be reduced.

Upon determining from the detection result using the underwater recognition sensor 190 that the current image capture condition is an underwater condition (YES of 904), the controller 100 calculates and stores a white balance compensation coefficient based on the underwater condition (906). When an S2 signal is generated to capture an image, the image signal processor 50 performs white balance compensation with reference to the white balance compensation coefficient based on the underwater condition. Upon determining at operation 904 that the current image capture condition is not an underwater condition (NO of 904), the controller 100 calculates and stores a white balance compensation coefficient based on another condition different from the underwater condition (908). In this case, when an S2 signal is generated to capture an image, the image signal processor 50 performs white balance compensation with reference to the white balance compensation coefficient based on the other condition different from the underwater condition. In the white balance compensation shown in FIG. 9, a message indicating to a user that the current image capture condition is the underwater condition is not displayed to reduce computational load applied to the controller 100 and the image signal processor 50 as in exclusion of the determination of the underwater condition through the analysis of the input image.

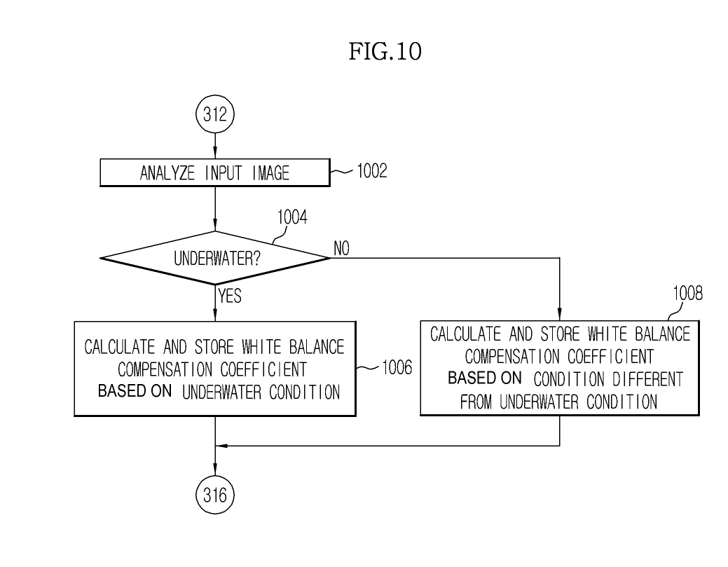

FIG. 10 is a flowchart showing a further embodiment of white balance compensation of the image capture method shown in FIG. 3. In the white balance compensation method shown in FIG. 10, an underwater condition is detected through only analysis of an input image without determination of an underwater condition using the underwater recognition sensor 190. In this embodiment, the image capture apparatus 150 performs an underwater condition detection algorithm through analysis of the input image.

That is, an input image is analyzed to determine whether a current image capture condition is an underwater condition (1002). In this embodiment, it is determined whether the current image capture condition is an underwater condition using only analysis of the input image without determination of the underwater condition using the underwater recognition sensor 190. Consequently, the underwater recognition sensor 190 is not necessary, thereby reducing the number of components within the image capture apparatus 150 and thus reducing the volume and weight of the image capture apparatus 150 and, in addition, reducing the number of manufacturing processes for the image capture apparatus 150.

Upon determining through the analysis of the input image that the current image capture condition is an underwater condition (YES of 1004), the controller 100 calculates and stores a white balance compensation coefficient based on the underwater condition (1006). When an S2 signal is generated to capture an image, the image signal processor 50 performs white balance compensation with reference to the white balance compensation coefficient based on the underwater condition.

Upon determining at operation 1004 that the current image capture condition is not an underwater condition (NO of 1004), the controller 100 calculates and stores a white balance compensation coefficient based on another condition different from the underwater condition (1008). In this case, when an S2 signal is generated to capture an image, the image signal processor 50 performs white balance compensation with reference to the white balance compensation coefficient based on the other condition different from the underwater condition.

In accordance with various embodiments of the invention as described above, white balance compensation of the image capture apparatus 150 is automatically performed. Particularly in a case in which a current image capture condition is an underwater condition, white balance compensation based on colors of water is automatically performed, thereby easily and conveniently expressing natural colors when an image is captured in the underwater condition.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

Although a few embodiments of the invention have been shown and described, it would be appreciated by those skilled in the art that changes may be made in these embodiments without departing from the principles and spirit of the invention, the scope of which is defined in the claims and their equivalents.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

What is claimed is:

1. An image capture apparatus comprising:
an imaging device that converts an input optical signal into an electrical signal to generate image data;
an image signal processor that analyzes color information of the image data and performs white balance compensation on the image data;
an underwater recognition sensor that detects whether an image capture condition is an underwater condition; and
a controller that determines whether the image capture condition is the underwater condition based on
the color information analysis result of the image signal processor or
the detection result of the underwater recognition sensor;
wherein the controller controls the image signal processor to perform the white balance compensation, based on the underwater condition, upon the determination that the image capture condition is the underwater condition.

2. The image capture apparatus according to claim 1, wherein the image signal processor performs the color information analysis on at least one region of a predetermined size at a bottom corner of an entire area of the image.

3. The image capture apparatus according to claim 1, further comprising:
a white balance map that comprises a color temperature range that corresponds to colors of water, wherein
the image signal processor performs the white balance compensation based on the white balance map and the underwater condition.

4. The image capture apparatus according to claim 3, wherein the colors of water in the white balance map comprise blue-based colors that correspond to a bottom or inner wall of a pool.

5. The image capture apparatus according to claim 3, wherein the color temperature range that corresponds to the colors of water in the white balance map is about 7850K to 9350K.

6. The image capture apparatus according to claim 1, further comprising a display unit that displays a message when the image capture condition is the underwater condition, wherein the message indicates that the white balance compensation based on the underwater condition will be performed.

7. An image capture apparatus comprising:
an imaging device that converts an input optical signal into an electrical signal to generate image data;
an image signal processor that performs white balance compensation on the image data;
an underwater recognition sensor that detects whether an image capture condition is an underwater condition; and
a controller that determines whether the image capture condition is the underwater condition based on the detection result of the underwater recognition sensor;
wherein the controller controls the image signal processor to perform the white balance compensation, based on the underwater condition, upon the determination that the image capture condition is the underwater condition.

8. The image capture apparatus according to claim 7, further comprising:
a white balance map that comprises a color temperature range that corresponds to colors of water, wherein
the image signal processor performs the white balance compensation based on the white balance map and the underwater condition.

9. The image capture apparatus according to claim 8, wherein the colors of water in the white balance map comprise blue-based colors that correspond to a bottom or inner wall of a pool.

10. The image capture apparatus according to claim 9, wherein the color temperature range that corresponds to the colors of water in the white balance map is about 7850K to 9350K.

11. An image capture apparatus comprising:
an imaging device that converts an input optical signal into an electrical signal to generate image data;
an image signal processor that analyzes color information of the image data and performs white balance compensation on the image data; and
a controller that determines whether an image capture condition is an underwater condition based on the color information analysis result of the image signal processor;
wherein the controller controls the image signal processor to perform the white balance compensation, based on the underwater condition, upon the determination that the image capture condition is the underwater condition.

12. The image capture apparatus according to claim 11, wherein the image signal processor performs the color information analysis on at least one region of a predetermined size at a bottom corner of an entire area of the image.

13. The image capture apparatus according to claim 11, further comprising:
a white balance map that comprises a color temperature range that corresponds to colors of water, wherein
the image signal processor performs the white balance compensation based on the white balance map and the underwater condition.

14. The image capture apparatus according to claim 13, wherein the colors of water in the white balance map comprise blue-based colors that correspond to a bottom or inner wall of a pool.

15. The image capture apparatus according to claim 14, wherein the color temperature range that corresponds to the colors of water in the white balance map is about 7850K to 9350K.

16. A control method of an image capture apparatus comprising:
converting an input optical signal into an electrical signal to generate image data;
analyzing color information of the image data;
detecting whether an image capture condition is an underwater condition;
determining whether the image capture condition is the underwater condition based on the color information analysis result or the detection result; and
performing white balance compensation on the image data, based on the underwater condition, upon determining that the image capture condition is the underwater condition.

17. The control method according to claim 16, wherein the color information analysis is performed on at least one region of a predetermined size at a bottom corner of an entire area of the image.

18. The control method according to claim 16, further comprising:
providing a white balance map that comprises a color temperature range that corresponds to colors of water,
wherein performing the white balance compensation comprises performing the white balance compensation based on the white balance map and the underwater condition.

19. The control method according to claim 18, wherein the colors of water in the white balance map comprise blue-based colors that correspond to a bottom or inner wall of a pool.

20. The control method according to claim 19, wherein the color temperature range that corresponds to the colors of water in the white balance map is about 7850K to 9350K.

21. The control method according to claim 16, further comprising displaying a message through a display unit, the message indicating that the white balance compensation based on the underwater condition will be performed, when the image capture condition is the underwater condition.
